(19) United States
(12) Patent Application Publication
(10) Pub. No.: US 2020/0384447 A1
(43) Pub. Date: Dec. 10, 2020

(54) CARBON DIOXIDE CONVERSION METHOD USING METAL OXIDES

(71) Applicant: KOREA INSTITUTE OF ENERGY RESEARCH, Daejeon (KR)

(72) Inventors: Chan Young PARK, Sejong-si (KR); Sung Chan NAM, Daejeon (KR); Sung Youl PARK, Daejeon (KR)

(73) Assignee: KOREA INSTITUTE OF ENERGY RESEARCH, Daejeon (KR)

(21) Appl. No.: 16/738,544

(22) Filed: Jan. 9, 2020

(30) Foreign Application Priority Data
Jun. 4, 2019 (KR) 10-2019-0065995

(51) Int. Cl. B01J 23/78; C01G 51/00; C01G 49/00; B01J 35/02; C01B 32/40; C01B 32/05

(52) U.S. Cl. CPC B01J 23/78; C01G 51/66; C01G 49/0036; C01P 2004/62; C01B 32/40; C01B 32/05; B01J 35/026

(57) ABSTRACT

The present invention relates to a catalyst for converting CO₂ to synthetic fuel such as CO using metal oxides and a conversion method using the same. The CO₂ conversion catalyst according to the present invention can treat a large amount of CO₂ per unit mole and is oxidized. In the reduction cycle, the catalyst has relatively high structural stability and excellent long-term stability as a catalyst, and it has excellent activity as a CO₂ decomposition catalyst that can be used in a continuous flow reactor, such as for CO₂ decomposition at a relatively low temperature.

### TECHNICAL FIELD

The present invention relates to a catalyst for converting carbon dioxide (CO₂) into synthetic fuel such as carbon monoxide (CO) using metal oxides and a conversion method using the same.

### BACKGROUND ART

Increasing atmospheric CO₂ concentrations are the key cause of the climate change that threatens human survival. To control the CO₂ concentration, mainly the amount of industrial CO₂ must be reduced. While it is preferable to reduce the use of fossil fuels, it is also important to develop carbon capture, storage, and utilization (CCSU) technologies. Technologies for converting captured CO₂ into synthetic fuel afford the dual advantages of the reduction of greenhouse gases and the production of useful energy sources.

Fossil fuel consumption produced 27 billion tons of CO₂ in 2018, up 1.7% from 2017. Because most of the world's fossil fuel resources are used as fuels and only a part of them, as industrial raw materials, CO₂ emissions are inevitable as long as fossil fuels are used. Therefore, the importance of research to convert CO₂ in exhaust gas produced by combustion into synthetic fuel such as industrially useful CO has increased greatly.

Studies on CO₂ reduction have tried to decompose CO₂ using H₂. For example, cation-excess magnetite (Fe_{3+δ}O₄, δ=0.127) can be used to decompose CO₂: hydrogen plays a role in producing oxygen deficiencies in this metal oxide, and then, the oxygen-deficient metal oxide acts as an active catalyst for decomposing CO₂. In addition to Fe₃O₄, MFe₂O₄ (M=Zn, Mn, Co, Ni, Cu) have also been reported to serve as active catalysts for CO₂ decomposition.

However, the above results were obtained using small amounts of CO₂ in a small batch system on a laboratory scale, which was far from a practical industrial scale. Therefore, the development of technology that can operate with a continuous gas supply is essential for commercial use. The catalyst used for this purpose should have good CO₂ conversion efficiency and good CO production selectivity.

Another method uses a CO₂ conversion catalyst prepared by an electrochemical technique. However, this method is expensive owing to its high electric energy consumption and the need for additional equipment such as a membrane separation facility. In addition, the configuration of the catalyst production apparatus is complicated.

Korean Patent Registration No. 10-1286556 relates to a CO₂ immobilization catalyst and a manufacturing method for the same. The patent discloses a technique for activating magnetite (Fe₃O₄) to produce active magnetite (Fe₃O_{4-δ}) to catalyze the CO₂ exhaust gas generated by the combustion of fossil fuels, and a technique for converting CO₂ to methane by depositing nickel ions on the prepared active magnetite.

However, this CO₂ immobilization catalyst cannot be used in a continuous process, and it has limitations in that the CO₂ decomposition level has not yet reached the industrial application stage.

### PRIOR ART DOCUMENTS

### Patent Document

Korean Registered Patent No. 10-1286556

### DETAILED DESCRIPTION OF THE INVENTION

### Technical Problem

To solve the above mentioned problems, the present invention provides a CO₂ conversion catalyst that shows excellent catalytic activity for CO₂ in a continuous flow reaction and maintains safety over wide temperature and oxygen partial pressure (pO₂) ranges.

In addition, the present invention provides a method for effectively converting CO₂ into CO.

### Technical Solution

To solve the above mentioned problems, the present inventors select a metal oxide crystal structure containing at least two or more of Sr, Fe, and Co via oxygen to screen out catalysts having high O²⁻ ion and electron mobilities, and they develop a method for converting CO₂ using the same.

The present invention provides a catalyst for the CO₂ conversion reaction having a composition represented by Formula 1.

SrFeCo₁₋ₓO_{y} (SFCO) [Formula 1]

(0≤x<1, 2.0≤y≤4.0)

The present invention also provides a catalyst for the CO₂ conversion reaction where, in Formula 1, 0.2≤x≤0.8.

The present invention also provides a catalyst for the CO₂ conversion reaction having a composition represented by Formula 2.

SrFeO_{3-δ} (SFO, where δ≤1). [Formula 2]

The present invention also provides a catalyst for the CO₂ conversion reaction that has a particle size of 0.7 μm or less.

The present invention also provides a CO₂ conversion method using a metal oxide. The conversion method comprises the steps of selecting a catalyst for CO₂ conversion reaction of any one of the above; introducing the selected catalyst into a quartz reactor injecting a reducing gas into the reactor and performing heat-treatment to activate the catalyst; and injecting a gas containing CO₂ into the quartz reactor and supplying heat treatment to induce a CO₂ conversion reaction, wherein the reducing gas is one among an inert gas, hydrogen, and CO, the heat-treatment temperature in the catalyst activation step is in the range of 100-1000° C.; the heat-treatment temperature in the step of inducing the CO₂ conversion reaction is in the range of 300-800° C. (preferably in the range of 600-700° C.).

The present invention also provides a CO₂ conversion method using a metal oxide: the conversion method comprises the steps of preparing two quartz tubes each having an inlet and outlet; selecting one among the above catalysts for the CO₂ conversion reaction and injecting it into the two quartz tubes; activating the catalyst by connecting a reducing gas supply pipe to the inlet of the first quartz tube and a reducing gas recovery pipe to the outlet of the first quartz tube and performing heat-treatment; simultaneously with the catalyst activation step, inducing a CO₂ conversion reaction by connecting a CO₂ gas supply pipe to the inlet of the second quartz tube and a gas recovery pipe including the CO₂ conversion reactant to the outlet of the second quartz tube and performing heat-treatment; replacing the gas supply pipe and the gas recovery pipe connected to the first quartz tube with the gas supply pipe and the gas recovery pipe connected to the second quartz tube, respectively, after a predetermined time elapses; and periodically repeating the step of replacing the gas supply pipes and the gas recovery pipes with each other, wherein the reducing gas is one among an inert gas, hydrogen, and CO, and the heat-treatment temperature of the step of activating the catalyst and inducing the, CO₂ conversion reaction is in the range of 300-800° C. (preferably in the range of 600-700° C.).

The present invention also provides a CO₂ conversion method using a metal oxide, wherein the exchanging of the supply pipe and the recovery pipe may exchange heat-treatment temperatures of the first quartz tube and the second quartz tube with each other; wherein periodically repeating the step of replacing the gas supply pipes and the gas recovery pipes with each other comprises replacing the heat-treatment temperature; and wherein the heat-treatment temperature of the catalyst activation step is in the range of 100-1000° C.

### Advantageous Effects

The CO₂ conversion catalyst provided in the present invention can treat a large amount of CO₂ per unit mole, has a relatively high structural stability even in repeating oxidation-reduction cycles, has excellent long-term stability as a catalyst, and can decompose CO₂ at a relatively low temperature. It has excellent activity for use in continuous gas flow reactors.

### DESCRIPTION OF THE DRAWINGS

FIG. 1 shows a schematic diagram of the reactor for performing a continuous CO₂ decomposition reaction.

FIG. 2 shows secondary electron microscope images of a NiFe₂O₄ (NFO) catalyst sample in the prior art and a SrFeCo₁₋ₓO_{y} (SFCO) catalyst sample according to one embodiment of the present invention.

FIG. 3 shows thermogravimetric analysis (TGA) graphs and in-situ X-ray diffraction (XRD) results of a NFO catalyst sample in the prior art.

FIG. 4 shows TGA graphs and in-situ XRD results of a SFCO catalyst sample according to one embodiment of the present invention.

FIG. 5 shows graphs of the reduction behavior and CO₂ decomposition reactions with increasing temperature for the NFO catalyst sample in the prior art.

FIG. 6 shows results of the reduction behavior and CO₂ decomposition reactions with increasing temperature for the SFCO catalyst sample according to one embodiment of the present invention.

FIG. 7 shows the in-situ X-ray powder patterns of the SFO catalyst sample during reduction at 500≤T≤800° C. according to one embodiment of the present invention.

FIG. 8 shows Isothermal CO₂ decomposition results obtained using the SFO catalyst sample at various temperatures according to one embodiment of the present invention.

FIG. 9 shows results of the reduction behavior and CO₂ decomposition reactions at elevated temperature for the SFO catalyst sample according to one embodiment of the present invention.

FIG. 10 shows five cyclic reproducibility tests for CO₂ decomposition using the SFO catalyst sample at 700° C. according to one embodiment of the present invention.

FIG. 11 shows a suggested mechanism of the catalytic reaction for CO₂ decomposition using the SFO catalyst sample according to one embodiment of the present invention.

### EMBODIMENT

Prior to the description of the invention, the terms or words used in the specification and claims described below should not be construed as limiting in their usual or dictionary meanings. Therefore, the embodiments described in the specification and the drawings shown in the drawings are only the most preferred embodiments of the present invention and do not represent all of the technical idea of the present invention. It should be understood that there might be variations and various equivalents that may be substituted for them at the time of the present application.

Throughout this specification, when a part is said to “comprise” a certain component, it means that it can further comprise other components, without excluding the other components unless otherwise stated.

In describing the principles of the preferred embodiment of the present invention in detail, if it is determined that the detailed description of the related known functions or configurations may unnecessarily obscure the subject matter of the present invention, the detailed description thereof will be omitted.

In addition, the embodiments described in the specification and the drawings shown in the figures are only the most preferred embodiment of the present invention and do not represent all of the technical ideas of the present invention. It should be understood that there might be various equivalents that may be substituted for them at the time of the present application.

The present invention relates to a CO₂ conversion catalyst having a composition represented by Formula 1.

SrFeCo₁₋ₓO_{y} (SFCO) [Formula 1]

(0≤x<1, 2.0≤y≤4.0)

In Formula 1, x is preferably in the range of 0.2-0.8, and more preferably in the range of 0.3-0.7.

The present invention also relates to a CO₂ conversion catalyst having a composition represented by Formula 2.

SrFeO_{3-δ} (SFO) [Formula 2]

(δ≤1)

The present invention provides a catalyst for the CO₂ conversion reaction that has a particle size of 0.7 μm or less.

In the content range of the CO₂ conversion catalyst provided by the present invention, the catalyst structure can be changed to non-perovskite, peroveskite, and brownmillerite depending on the amount of oxygen in the lattice.

The CO₂ conversion catalyst embodied by the present invention may be prepared by a known production method such as sol-gel, co-precipitation, citrate complexation (complexation), hydrothermal synthesis, pyrolysis, or solid-state synthesis.

The CO₂ conversion catalyst embodied by the present invention has a crystal structure in which at least two metal species (Sr, Fe, Co) are bonded through oxygen, and it has high oxygen ion (O²⁻) and electron (e⁻) mobilities that are believed to drive an efficient CO₂ decomposition reaction.

In the present invention, the CO₂ conversion catalyst is characterized by the fact that it is activated in an inert gas and/or hydrogen atmosphere before the CO₂ conversion.

The inert gas can be among nitrogen, argon, helium, krypton, neon, xenon, and radon, and in consideration of economic efficiency, it is preferable to use nitrogen or argon.

The CO₂ conversion catalyst may be activated at a temperature in the range of 100-1000° C. (preferably 300-800° C.), and a lower temperature is advantageous for applying it to industrial processes. Almost no oxygen-deficient structure can be produced below 100° C., and the catalyst structure may collapse above 1000° C.

As a result of this heat-treatment, the lattice oxygen in the CO₂ conversion catalyst is partially removed to form an oxygen-depletion structure, thereby activating the catalyst. The greater the oxygen deficiency, the greater is the ability to decompose and convert CO₂. Therefore, it is advantageous to remove as much lattice oxygen as possible without causing the irreversible collapse of the catalyst structure.

The CO₂ conversion catalyst embodied by the present invention can be ground through a grinding process to improve its specific surface area of the catalyst. The grinding step is preferably carried out within a range that does not destroy the oxygen defect structure of the CO₂ conversion catalyst. Pulverization can be performed using conventional methods, such as, a ball-mill process. Through the above grinding process, the CO₂ conversion catalyst provided by the present invention may be pulverized to an appropriate size of 700 nm or less (preferably 200 nm or less).

It is possible to convert CO₂ more efficiently using the CO₂ conversion catalyst SFCO according to one embodiment of the present invention.

The CO₂ conversion method embodied by the present invention involves, selecting the catalyst for the CO₂ conversion reaction; introducing the selected catalyst into a quartz reactor; injecting a reducing gas into the reactor and performing heat-treatment to activate the catalyst; and injecting a gas containing CO₂ into the quartz reactor and performing heat treatment to induce a CO₂ conversion reaction.

In one embodiment of the present invention, the reducing gas is one among an inert gas, hydrogen, and CO.

In one embodiment of the present invention, the heat-treatment temperature for the catalyst activation step is in the range of 100-1000° C., and the heat-treatment temperature for the step of inducing the CO₂ conversion reaction is in the range of 300-800° C. (preferably is in the range of 600-700° C.).

In one embodiment of the present invention, the CO₂ conversion method using a metal oxide is a continuous process that involves preparing two quartz tubes each having an inlet and outlet; selecting a catalyst for the CO₂ conversion reaction of any one of the above and injecting it into the two quartz tubes; activating the catalyst by connecting a reducing gas supply pipe to the inlet of the first quartz tube and reducing gas recovery pipe to the outlet of the first quartz tube and performing heat-treatment; simultaneously with the catalyst activation step, inducing a CO₂ conversion reaction by connecting a gas supply pipe including carbon dioxide to the inlet of the second quartz tube and a gas recovery pipe including the CO₂ conversion reactant to the outlet of the second quartz tube and performing heat-treatment; replacing the gas supply pipe and the gas recovery pipe connected to the first quartz tube with the gas supply pipe and the gas recovery pipe connected to the second quartz tube, respectively, after a predetermined time elapses; and periodically repeating the step of replacing the gas supply pipes and the gas recovery pipes with each other.

In one embodiment of the present invention, the reducing gas is one among an inert gas, hydrogen, and CO.

In one embodiment of the invention, the heat-treatment temperature for the step of activating the catalyst and inducing the CO₂ conversion reaction is in the range of 300-800° C. (preferably in the range of 600-700° C.).

In another embodiment of the invention, the CO₂ conversion method using a metal oxide is a continuous process, wherein the exchanging of the supply pipe and the recovery pipe may comprise exchanging the heat treatment temperatures of the first quartz tube and the second quartz tube with each other, wherein periodically repeating the step of replacing the gas supply pipes and the gas recovery pipes with each other comprises replacing the heat-treatment temperatures, and wherein the heat-treatment temperature of the catalyst activation step is in the range of 100-1000° C.

Hereinafter, the present invention will be described in more detail with reference to preferred examples. However, these examples are intended to illustrate the present invention in more detail, and it will be apparent to those skilled in the art that the scope of the present invention is not limited thereby.

### Example 1

SrFeCo_{0.5}Oₓ (SFCO) was prepared as a catalyst for decomposing CO₂ according to the present invention as follows.

Fe₂O₃ (AlfaAesar, >99.9%), SrCO₃ (AlfaAesar, >99%) and Co₃O₄ (AlfaAesar, >99.7%) were weighed and mixed in a suitable amount of ethanol (Samchun Chemicals, >99.9%) to form SrFeCo_{0.5}Oₓ.

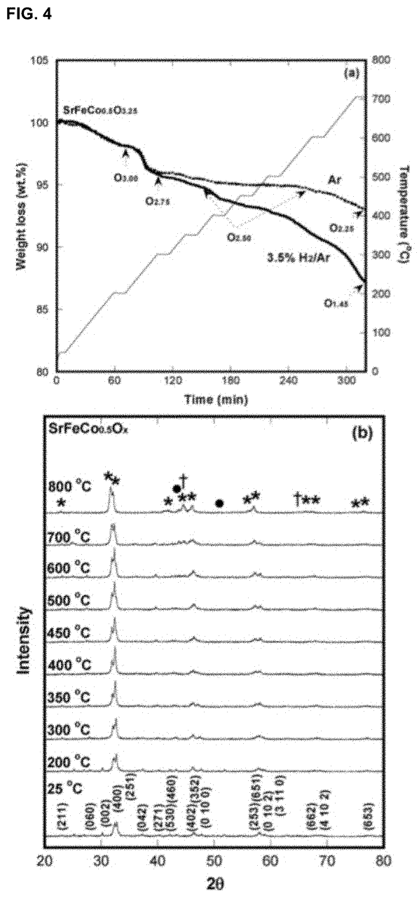

The mixed powder was ball-milled with zirconia balls (φ3-5 mm) for 48 h and then, the solvent was evaporated to dryness. The dried powder was heated to 1100° C. at a rate of 3° C./min in air in a kiln and calcined at 1100° C. for 3 h to obtain SFCO. The obtained SFCO was again ball-milled for 24 h and then dried at 80° C. in a drying oven for 24 h. FIG. 4 shows XRD measurement results of the prepared sample; it was confirmed that the SFCO structure was well formed.

### Comparative Example 1

NiFe₂O₄ (NFO), which is known to have high CO₂ decomposition capability as a comparative catalyst, was prepared as follows.

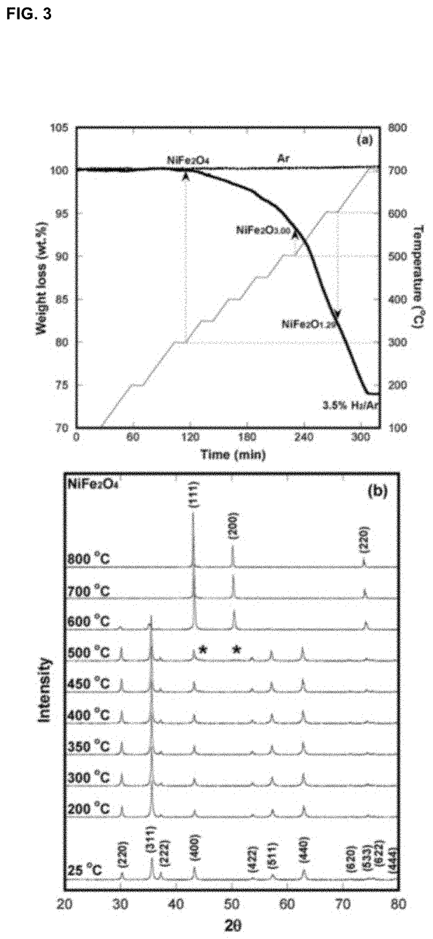

The processes for the Comparative Example 1 are the same as those for Example 1 except that NiO (Kojundo Chemical Laboratory Co. Ltd., >99.97%) and Fe₂O₃ (AlfaAesar, >99.9%) were weighed and mixed in an appropriate amount of ethanol solvent and fired at 1000° C. to obtain NFO. FIG. 3 shows XRD measurement results of the prepared sample; it was confirmed that the NFO structure was well formed.

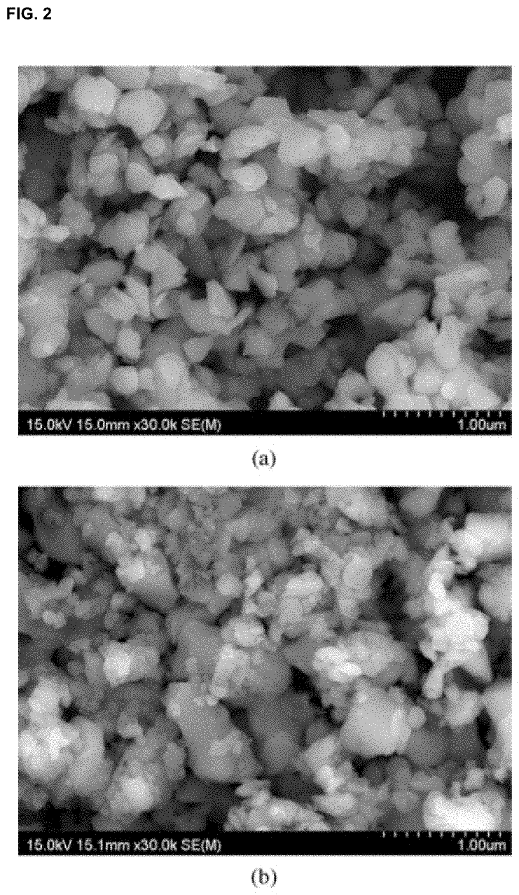

FIG. 2 shows SEM images of the samples prepared in Example 1 and Comparative Example 1. FIG. 2(a) shows an SEM image of the NFO sample prepared in Comparative Example 1. The particles are generally spherical, have sizes of 200-400 nm, and are formed relatively uniformly.

FIG. 2(b) shows an SEM image of the SFCO sample prepared in Example 1. In this case, small particles of 50-200 nm size are distributed on the surface of large particles of 500-700 nm size. SFCO with fine and uniform particle sizes can be expected to be produced via the longer ball-milling times or use of other synthetic methods such as the co-precipitation technique.

Structural Changes in Reduction Process of SFCO and NFO

To observe the structural change in the reduction process for the activation of the CO₂ conversion catalyst prepared in Example 1 and Comparative Example 1, in-situ XRD (Dmax-2500pc, Rigaku XRD) was measured as the temperature was increased from room temperature to 800° C. using 3.5 vol. % H₂/Ar. The gas flow rate was adjusted to 100 ml/min and the temperature was increased at a rate of 3° C./min and kept constant for 12 min for the in-situ XRD measurements.

TGA (TA Instruments) was used to evaluate the weight change of the catalyst under the same conditions as in-situ XRD except that the temperature was increased up to 700° C. To measure the weight change under an inert atmosphere, the measurement was performed by passing only 99.999 vol. % Ar gas. The amount of sample used was 50 mg, and the flow rate and ramp rate were set at 100 ml/min and 3° C./min, respectively.

FIG. 3 shows TGA and in-situ XRD results for NFO. In the case of NFO as a comparative example, because hardly any weight loss occurs below 300° C., the NFO hardly reacts with hydrogen below 300° C. In this temperature range, the XRD pattern reveals only a spinel structure without any other structural change.

Above 300° C., the weight loss a increases sharply from 400 to 450° C. At 500° C., theoretically, the weight decreases as one of the four oxygens of NFO is removed. If the temperature is increased further to 600° C., the weight decreases at a faster rate, resulting in a weight loss of ˜18.5 wt. % of the initial weight. At just below 700° C., the weight is reduced to ˜26 wt. % of the initial weight. At higher temperatures, no further weight loss occurred. On the other hand, no weight loss occurred underAr gas without hydrogen (see dashed line in FIG. 3(a)).

In the XRD pattern, the spinel structure is well preserved below 500° C. However, at 500° C., minor secondary phase traces begin to appear. Further, when the temperature is increased to 600° C., the phase of NFO and Ni—Fe alloys is mixed. Above 700° C., the spinel structure is completely destroyed and the Ni—Fe alloy forms the main phase; further, the original single phase is not completely recovered even in the case of oxidization with CO₂.

FIG. 4 shows TGA and in-situ XRD results for SFCO. SFCO reacted with ˜3.5 vol. % H₂ at over 100° C. and reached 300° C., resulting in a weight loss of about ˜5 wt. % of the initial weight; this shows same weight loss trend as that in the presence of Ar gas without hydrogen. Arithmetic calculations suggest a conversion to the brownmillerite structure at ˜375° C. The results indicate that SFCO can be reduced and activated more easily than NFO.

In the in-situ XRD graph, the main structure of SFCO is seen to remain unchanged up to 700° C. Even at 800° C., only small amounts of Fe metal (†, PDF#01081-8771) and Co—Fe alloy (•, PDF#01-075-7975) are produced, and the SFCO lattice is maintained and only structural deformation occurs rather than complete decomposition. The reduction in total weight was ˜12.8% after reduction with 3.5 vol. % H₂/Ar. SFCO was found to be able to produce oxygen deficiencies without the use of hydrogen because a significant amount of weight reduction (in theory, reduction to brownmillerite at 600° C. or lower) occurs even under inert gas (Ar).

### Example 2

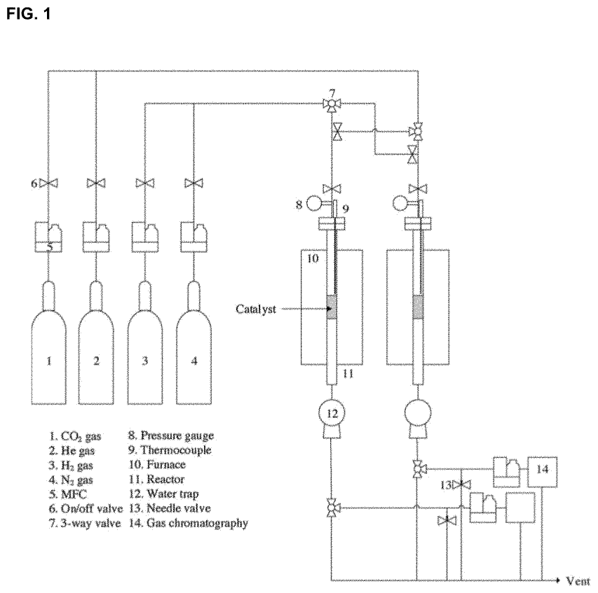

FIG. 1 shows a schematic of the continuous flow reactor to test the CO₂ decomposition reactivity of the SFCO catalyst. The reactor used two vertical furnaces to allow CO₂ decomposition to proceed in the other reactor while activating the catalyst in one reactor.

In the experiment, 1.5 g of the SFCO catalyst powder prepared in Example 1 was filled in a quartz reactor (I.D.: 12 mm, O.D.: 16 mm, height 25 mm) together with zirconia balls (2-3 mm, 10 g), and then heated at a rate of 3° C./min up to 800° C. while flowing 3.5 vol. % H₂/N₂ at 100 ml/min to remove the lattice oxygen in the catalyst to activate the catalyst. After the temperature was decreased to room temperature by flowing He gas, 1 vol. % CO₂/N₂ was flowed at 50 ml/min, and then, the reactor temperature was increased to 800° C. to perform a CO₂ conversion reaction. The procedure was repeated twice to confirm the reproducibility of the catalyst.

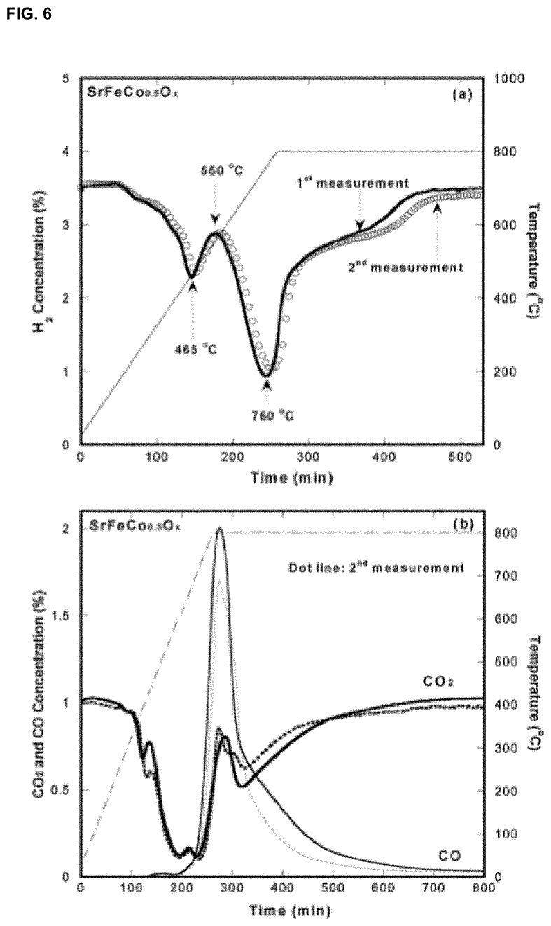

Gas exiting the reactor was analyzed using gas chromatography (GC); the results are shown in FIG. 6.

### Comparative Example 2

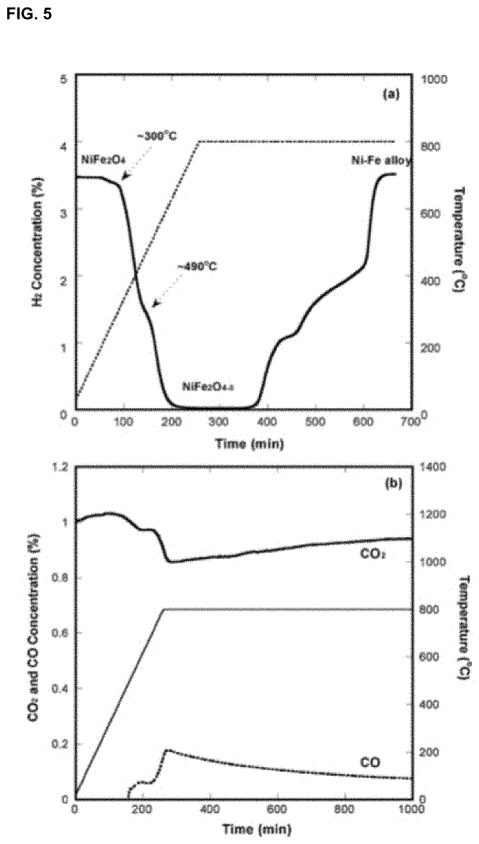

The CO₂ conversion reaction was performed by the same process as in Example 2 using NFO prepared in Comparative Example 1 as a catalyst. Repeated experiments for confirming reproducibility were not conducted. Gas exiting the reactor was analyzed using GC; the results are shown in FIG. 5.

FIG. 5 shows CO₂ decomposition result using the NFO catalyst of Comparative Example 2. In FIG. 5(a), hydrogen is consumed above 300° C. in the reduction reaction of an NFO catalyst, and above 630° C., almost all hydrogen injected into the reactor reacts with a catalyst material and is not detected on the analyzer. Even after reaching 800° C., the hydrogen was completely consumed for a while. After complete hydrogen reduction is performed to the point where hydrogen consumption stops, the CO₂ decomposition reaction is performed using the reduced NFO; the results are shown in FIG. 5(b). In FIG. 5(b), only less than 20% of CO₂ was decomposed, and the concentration of the generated CO was not high.

CO₂ decomposition experiments were performed using NiFe₂O_{4-δ}; the spinel structure of NFO did not completely collapse and contained partial oxygen defects, and the CO₂ decomposition efficiency remained insignificant.

FIG. 6 shows the experimental result obtained using the SFCO catalyst of Example 1. FIG. 6(a) shows the result of the SFCO reduction process using 3.5% H₂/N₂ gas. Hydrogen was hardly consumed below 200° C., and hydrogen consumption was increased greatly at 465° C. and 760° C. The former was attributed to the reduction of Co³⁺ ions and the latter, to the reduction of Fe³⁺ ions. Then before 800° C., the hydrogen concentration was found to increase again. This is similar to the TGA test, and in the case of SFCO, it means that a certain amount of oxygen exists in the SFCO lattice; the SFCO lattice structure is maintained, indicating its excellent reduction durability and the possibility of recovering it to the starting material.

FIG. 6 (b) shows the CO₂ conversion rate of SFCO activated through the above process. In Example 2, the CO₂ conversion reaction showed a maximum conversion rate of 90% according to the reaction temperature; in particular, the CO₂ decomposition efficiency exceeded 80% for at least 1 h for temperatures of 550-750° C.

On the other hand, the decrease in CO₂ concentration starts at 260° C., and CO starts to appear at 420° C. This is because CO₂ is initially adsorbed to the catalyst surface in the molecular state during the reaction process, and when CO₂ decomposition occurs it can be reduced to CO or carbon (C). The complete reduction of CO₂ to carbon is expected to occur mainly at temperatures below 640° C. As the temperature increases further, the CO concentration increases rapidly, and at 800° C., the CO concentration decreases gradually. This result is presumed to be due to the reverse Boudouard reaction (C(s)+CO₂→CO), in which the produced carbon reacts with CO₂ again to produce CO. As the second measurement shows a similar trend, it is possible to confirm the experimental reliability of the catalyst produced in the present invention.

As described above, SFCO produced in the present invention shows an extremely high CO₂ conversion rate and CO generation amount compared to NFO, and it is confirmed to be suitable as a CO₂ conversion catalyst that shows high structural stability.

### Example 3

SrFeO_{3-δ} (SFO) was prepared as a catalyst for decomposing CO₂ according to the present invention as follows.

Fe₂O₃ (AlfaAesar, >99.9%) and SrCO₃ (AlfaAesar, >99%) were respectively weighed and mixed in an appropriate amount of ethanol (Samchun Chemicals, >99.9%) to produce SFO.

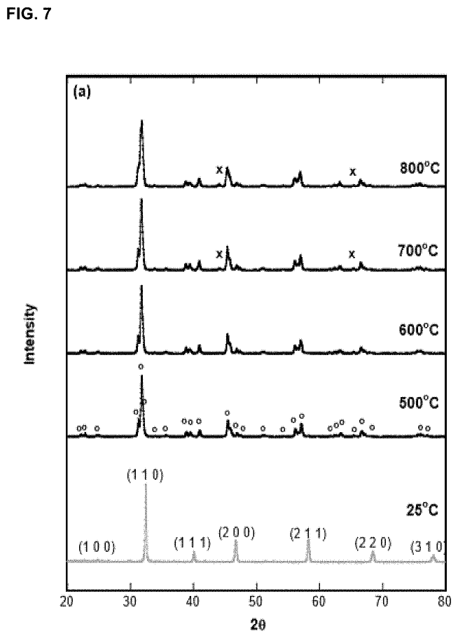

The mixed powder was ball milled with zirconia balls (φ3-5 mm) for 48 h and then the solvent was evaporated to dryness for 48 h. The SFO powder was heated in air at 1000° C. for 3 h. The obtained SFO powder was ball-milled with ethanol for 24 hours, and then dried at 80° C. for 24 hours in a drying oven. In-situ XRD was performed during high-temperature reduction by 3.5 vol. % H₂/Ar to identify the reduction behaviors occurring in the catalyst. FIG. 7 shows the In-situ X-ray powder patterns of SrFeO_{3-δ} during reduction at 500≤T≤800° C. SrFeO_{3-δ} was determined to be in the perovskite phase at room temperature (PDF#01-077-9154). As the temperature increased, the SrFeO_{3-δ} perovskite could lose more oxygen and an almost pure brownmillerite phase (SrFeO_{2.5}, PDF#01-070-0836) was observed from 500° C. The perovskite phase is expected to start to change to brownmillerite at ˜364° C. via the reduction of Fe⁴⁺ to Fe³⁺. This agrees well with temperature programmed reduction (TPR) and TGA results. The XRD patterns at 500° C. were completely indexed with an orthorhombic unit cell with lattice parameters a=5.69(9) Å, b=15.80(2) Å, c=5.57(2) Å, and V=501.8(8) Å³. Srₙ₊₁FeₙO₃ₙ₊₁ and Fe⁰ peaks were reported to appear if SrFeO_{2.5} was reduced further by increasing the temperature and reaction time. SrO and Fe⁰ peaks are considered to be the final products of the reduction. In FIG. 7, only a trace of Fe metal (PDF#01-080-3817) peaks appeared at 2θ≈44.1° and 65.4° at ≥700° C. Typical Fe⁰ peaks can be observed at 2θ≈44.0° and 65.3°. An Sr₃Fe₂O_{6.14} phase might exist; however, it could be overlapped with the brownmillerite peaks.

### Example 4

To test the CO₂ decomposition reactivity of the SrFeO_{3-δ} (SFO) catalyst produced in the present invention, a continuous flow reactor was used as shown in FIG. 1.

In the experiment, 1.5 g of the catalyst powder prepared in Example 3 was filled in a quartz reactor (I.D.: 12 mm, O.D.: 16 mm, height 600 mm) with zirconia balls (φ2-3 mm, 10 g), following which 3.5 vol. % H₂/N₂ was flowed at 50 ml/min. The temperature was increased to 800° C. at a rate of 3° C./min to remove oxygen in the catalyst lattice to activate the catalyst. After the reactor temperature was decreased to room temperature while flowing He gas, CO₂ decomposition was carried out using 1 vol. % CO₂/He (50 ml/min) with increasing temperature up to 800° C. Isothermal measurements of CO₂ were also carried out between 500 and 800° C. Under non-isothermal conditions, up to 90% CO₂ conversion was seen, and over 170 min, the CO₂ decomposition efficiency exceeded 80%.

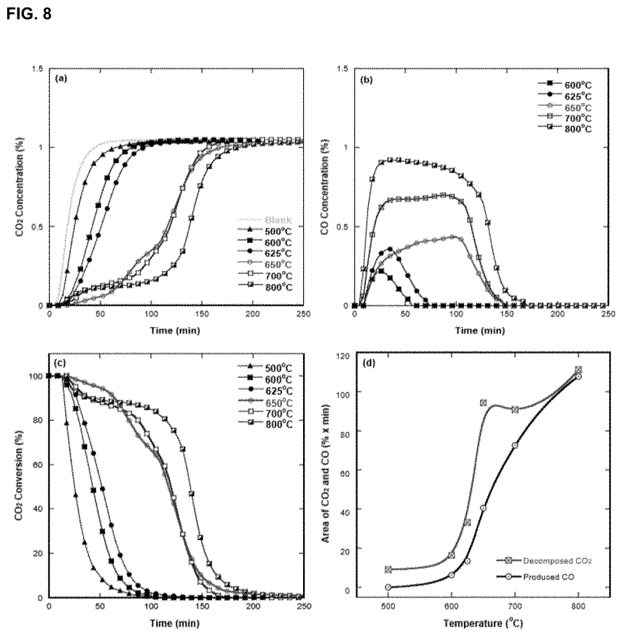

FIG. 8 shows the result of the CO₂ conversion reaction in isothermal conditions between 500 and 800° C. The best efficiency was achieved at 650 and 700° C. For practical applications, CO₂ decomposition data using SrFeO_{3-δ} at constant temperature should be accumulated; FIG. 8 shows the isothermal results. The measurements were performed at 500, 600, 625, 650, 700, and 800° C. The temperatures for sample activation and decomposition were identically controlled, and a blank test was performed in the same reactor. GC was used to determine the data points every ˜4 min after switching the gas with 1 vol. % CO₂/He. Fresh powder samples were used in each measurement. As the temperature increased, the amounts of CO₂ decomposed and CO produced increased. This is probably attributable to the amount and high mobility of oxygen vacancies at higher temperatures. The ionic conductivities are proportional to the mobility of perovskite metal oxides (i.e., σ=n.e.p, where a is the specific conductivity; n, the number of charge carriers of a species; e, its charge; and p, its mobility) and generally increases with the temperature.

The CO₂ decomposition results between 600 and 700° C. are very noteworthy. As the operating temperature increases from 625 to 650° C., the amount of CO₂ decomposed increases by more than two times. In-situ XRD and TGA experiments were performed to analyze this unusual behavior in this temperature range. However, no special structural phase or weight changes were seen in the sample activation process. The amount of hydrogen consumed for sample activation and the cell parameters also showed no big difference. The reason for the sudden increase in CO₂ decomposition upon increasing the temperature by only 25° C. remains unclear. It is presumed that the thermal energy at 650° C. might boost CO₂ decomposition and the reverse Boudouard reaction (i.e., C(s)+CO₂-+2CO). The mobility increase caused by the thermal energy might be an important factor because other factors such as the unit cell volume, oxygen ion vacancy concentration, and weight change from TGA did not change abruptly.

Based on the obtained data, CO₂ conversion rates were calculated using equation (1).

$${CO}_{2} Conversion ( \% ) = \frac{{CO}_{2} In - {CO}_{2} Out}{{CO}_{2} In} \times 100 \qquad ( 1 )$$

In the CO₂ conversion plot, ≥90% of CO₂ conversion lasted for %65 min at 650° C. This drastic change is much more evident from the area plots of the decomposed CO₂ and produced CO shown in FIG. 8(d). These areas were calculated by subtracting those obtained in the isothermal blank tests. It should be noted that the area for CO₂ (i.e., amount of CO₂ decomposed) is unusually high at 650° C.; it is even slightly higher than that at 700° C. Further, CO production increased rapidly until the temperature increased up to 800° C. The shape of the isothermal CO₂ decomposition curve at 650° C. is also slightly different from those of the others.

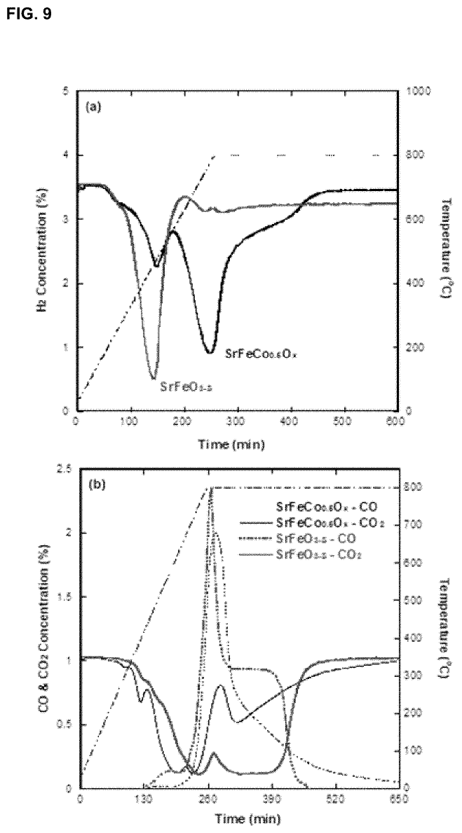

Nonisothermal CO₂ decomposition experiments were conducted in a continuous flow reactor to investigate the characteristics of CO₂ decomposition with temperature. FIG. 9 shows a comparison of the results of CO₂ decomposition using SrFeO_{3-δ} and SrFeCo_{0.5}Oₓ for temperatures of 25-800° C. Data for SrFeCo_{0.5}Oₓ were extracted from a previous report and the same experimental conditions were applied. Hydrogen consumption indicates that the reduction proceeds to produce oxygen vacancies in the catalysts. As confirmed by the reduction behavior analysis, the reduction of metals in the catalyst mainly occurred at a specific temperature. For the reduction of cobalt-containing SrFeCo_{0.5}Oₓ, hydrogen is mainly consumed ˜500° C. and at 700-800° C. At these temperatures, the most oxygen vacancies are created. Even after reaching 800° C., the activation process continues to reduce the catalyst completely. Theoretically, the activation process can be terminated after creating the maximum number of oxygen vacancies. As found in the TPR experiments, these two characteristic peaks correspond to the reduction of cobalt and iron.

SrFeO_{3-δ} can be activated at a much lower temperature and for a shorter duration. SrFeO_{3-δ} is mostly activated at 280≤T≤600° C., as shown in FIG. 9(a). The H₂ concentration during reduction decreased rapidly up to ≈460° C., which indicates the phase changes from perovskite to brownmillerite. This behavior can be confirmed from the reduction behavior results. The reduction of perovskite SrFeO_{3-δ} to brownmillerite mainly completed at ≤700° C. At ≥700° C., the brownmillerite phase reduced further the small hydrogen consumption of ≈0.2% indicates the difficulty and slow kinetics of the inner oxygen extraction. FIG. 9(b) shows the change in the decomposed CO₂ and produced CO concentrations during the CO₂ decomposition experiment. In the previous work, CO₂ decomposition is started with NiFe₂O₄ as the catalyst; however, it decomposed only up to 20% of CO₂ in the continuous gas flow system. CO₂ decomposition efficiency of 90% of was obtained using SrFeCo_{0.5}Oₓ selected based on the proposed mechanism. In this work, several enhanced CO₂ decomposition results were obtained using SrFeO_{3-δ}. The amount of CO₂ decomposed using SrFeO_{3-δ} is around 2.2 times higher than that decomposed using SrFeCo_{0.5}Oₓ based on the calculation result of ≥50% CO₂ decomposition. The amount of CO produced using SrFeO_{3-δ} is also slightly higher than that produced using SrFeCo_{0.5}Oₓ. In addition, SrFeO_{3-δ} is a cobalt-free compound that is economical and environmentally friendly. Generally, cobalt-containing metal oxides show good catalytic behavior but have several shortcomings such as cost and long-term catalytic deactivation.

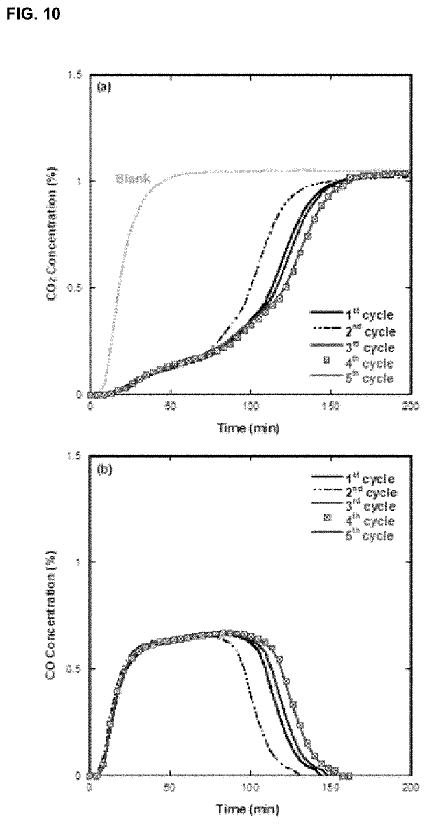

As another example of a stability test, a five-cycle test (i.e., five redox reactions) was performed at 700° C. FIG. 10 shows the decomposition results obtained using partially activated SFO samples at 650° C.: (a) CO₂ concentration and (b) CO concentration. Although the results of the second cycle differed from those of the first cycle, the data for the third cycle was recovered and was reasonably reproducible. Further, after the fourth and fifth cycles, the data indicated slightly enhanced efficiency and a significantly good match. The results clearly indicate that SrFeO_{3-δ} is a reproducible and reliable CO₂ decomposition catalyst at 700° C.

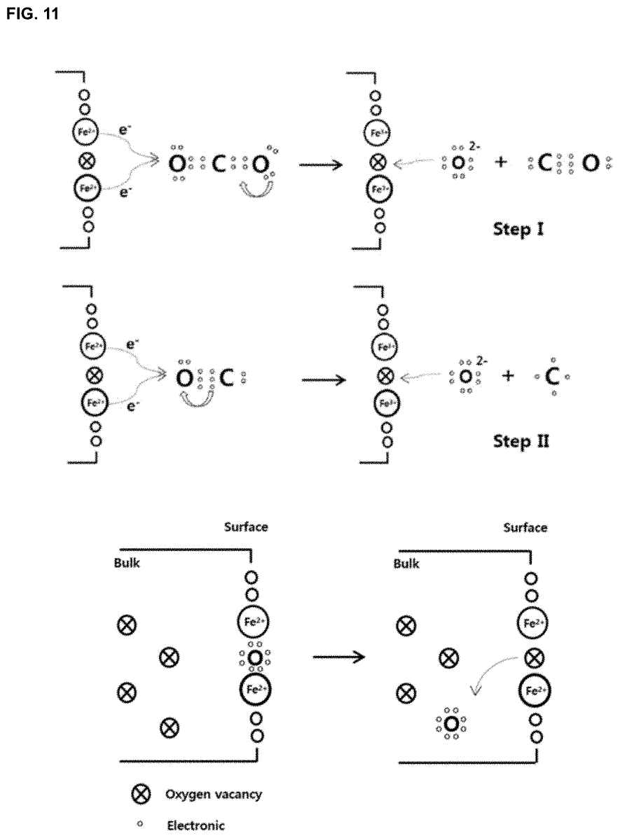

The CO₂ catalysts should have high electronic and oxygen ionic conducting properties as well as durability in severe gas conditions. The followings are the suggested reaction mechanism as shown as in FIG. 11 for CO₂ decomposition using SrFeO₃. CO₂ decomposition using SrFeO_{3-δ} involves two processes; activation (Eq. 2) and oxidation (Eq. 3) of the catalyst.

SrFeO₃+H₂→SrFeO_{3-δ}+H₂O (2)

SrFeO_{3-δ}+CO₂→SrFeO₃+CO or C (3)

During the activation of SrFeO₃, Fe ions are reduced from Fe⁴⁺ to Fe³⁺ to Fe²⁺ and/or Fe⁰ while simultaneously generating oxygen vacancies. The produced oxygen vacancies are likely to withdraw O²⁻ in nature and can be a driving force for CO₂ decomposition. For this purpose, a stable structure like SrFeO_{3-δ} over a wide pO₂ region is important. The reverse Boudouard reaction (Eq. 4) might be another key factor as the decomposition temperature increases owing to the possibility of a reaction between the produced carbon and the feed CO₂.

C(s)+CO₂→2CO (4)

The embodiments of the present invention described above should not be construed as limiting the technical idea of the present invention. The protection scope of the present invention is limited only by the matters described in the claims, and those skilled in the art can change the technical idea of the present invention in various forms. Therefore, such improvements and modifications will fall within the protection scope of the present invention, as will be apparent to those skilled in the art.

1. A catalyst for converting CO₂ having a composition represented by Formula 1:
SrFeCo₁₋ₓO_{y} (SFCO), [Formula 1]
wherein: 0≤x<1, and 2.0≤y≤4.0.

2. The catalyst of claim 1, wherein in Formula 1, x is 0.2-0.8.

3. A catalyst for converting CO₂ having a composition represented by Formula 2:
SrFeO_{3-δ} (SFO), [Formula 2]
wherein δ≤1.

4. The catalyst of claim 1,
wherein the catalyst has a particle size of 0.7 μm or less.

5. A CO₂ conversion method using a metal oxide:
wherein the conversion method comprises the steps of selecting a catalyst for CO₂ conversion of any one of the catalysts described in claim 1;
introducing the selected catalyst into a quartz reactor;
injecting a reducing gas into the reactor and performing heat-treatment to activate the catalyst; and
injecting a gas containing CO₂ into the quartz reactor and performing heat-treatment to induce a CO₂ conversion reaction,
wherein the reducing gas is one among an inert gas, hydrogen, and CO; the heat-treatment temperature of the catalyst activation step is in the range of 100-1000° C.; and the heat-treatment temperature of the step of inducing the CO₂ conversion reaction is in the range of 300-800° C.

6. The method of claim 5,
wherein the heat-treatment temperature of the step of inducing the CO₂ conversion reaction is in the range of 600-700° C.

7. A CO₂ conversion method using a metal oxide:
wherein the conversion method comprises the steps of preparing two quartz tubes each having an inlet and an outlet;
selecting the catalyst of claim 1 for the CO₂ conversion reaction and injecting into the two quartz tubes;
activating the catalyst by connecting a reducing gas supply pipe to the inlet of the first quartz tube and a reducing gas recovery pipe to the outlet of the first quartz tube and performing heat-treatment;
simultaneously with the catalyst activation step,
inducing a CO₂ conversion reaction by connecting a gas supply pipe including CO₂ to the inlet of the second quartz tube and a gas recovery pipe including the CO₂ conversion reactant to the outlet of the second quartz tube and performing heat-treatment;
replacing the gas supply pipe and the gas recovery pipe connected to the first quartz tube with the gas supply pipe and the gas recovery pipe connected to the second quartz tube, respectively, after a predetermined time elapses; and
periodically repeating the step of replacing the gas supply pipes and the gas recovery pipes with each other,
wherein the reducing gas is one among an inert gas, hydrogen, and CO, and the heat-treatment temperature of the step of activating the catalyst and inducing the CO₂ conversion reaction is in the range of 300-800° C.

8. The method of claim 7,
wherein the heat-treatment temperature of the step of activating the catalyst and inducing the CO₂ conversion reaction is in the range of 600-700° C.

9. The method of claim 7,
wherein the exchanging of the supply pipe and the recovery pipe optionally comprises exchanging the heat-treatment temperatures of the first quartz tube and the second quartz tube with each other,
wherein periodically repeating the step of replacing the gas supply pipes and the gas recovery pipes with each other comprises replacing the heat-treatment temperatures, and
wherein the heat-treatment temperature of the catalyst activation step is in the range of 100-1000° C.

10. The catalyst of claim 3,
wherein the catalyst has a particle size of 0.7 μm or less.

11. CO₂ conversion method using a metal oxide:
wherein the conversion method comprises the steps of selecting a catalyst for CO₂ conversion of the catalyst described in claim 3;
introducing the selected catalyst into a quartz reactor;
injecting a reducing gas into the reactor and performing heat-treatment to activate the catalyst; and
injecting a gas containing CO₂ into the quartz reactor and performing heat-treatment to induce a CO₂ conversion reaction,
wherein the reducing gas is one among an inert gas, hydrogen, and CO; the heat-treatment temperature of the catalyst activation step is in the range of 100-1000° C.; and the heat-treatment temperature of the step of inducing the CO₂ conversion reaction is in the range of 300-800° C.

12. A CO₂ conversion method using a metal oxide:
wherein the conversion method comprises the steps of preparing two quartz tubes each having an inlet and an outlet;
selecting a catalyst any one of the catalysts described in claim 3 for the CO₂ conversion reaction and injecting into the two quartz tubes;
activating the catalyst by connecting a reducing gas supply pipe to the inlet of the first quartz tube and a reducing gas recovery pipe to the outlet of the first quartz tube and performing heat-treatment;
simultaneously with the catalyst activation step,
inducing a CO₂ conversion reaction by connecting a gas supply pipe including CO₂ to the inlet of the second quartz tube and a gas recovery pipe including the CO₂ conversion reactant to the outlet of the second quartz tube and performing heat-treatment;
replacing the gas supply pipe and the gas recovery pipe connected to the first quartz tube with the gas supply pipe and the gas recovery pipe connected to the second quartz tube, respectively, after a predetermined time elapses; and
periodically repeating the step of replacing the gas supply pipes and the gas recovery pipes with each other,
wherein the reducing gas is one among an inert gas, hydrogen, and CO, and the heat-treatment temperature of the step of activating the catalyst and inducing the CO₂ conversion reaction is in the range of 300-800° C.

13. The method of claim 8,
wherein the exchanging of the supply pipe and the recovery pipe optionally comprises exchanging the heat-treatment temperatures of the first quartz tube and the second quartz tube with each other,
wherein periodically repeating the step of replacing the gas supply pipes and the gas recovery pipes with each other comprises replacing the heat-treatment temperatures, and
wherein the heat-treatment temperature of the catalyst activation step is in the range of 100-1000° C.
